(19) United States
(12) Patent Application Publication
(10) Pub. No.: US 2017/0314089 A1
(43) Pub. Date: Nov. 2, 2017

(54) ZINC-COATED HOT FORMED HIGH STRENGTH STEEL PART WITH THROUGH-THICKNESS GRADIENT MICROSTRUCTURE

(71) Applicant: GM Global Technology Operations LLC, Detroit, MI (US)

(72) Inventor: Jianfeng Wang, Novi, MI (US)

(73) Assignee: GM Global Technology Operations LLC, Detroit, MI (US)

(21) Appl. No.: 15/141,272

(22) Filed: Apr. 28, 2016

(51) Int. Cl. C21D 9/00; B24C 1/10; C22C 38/38; C22C 38/28; C22C 38/06; C22C 38/04; C22C 38/02; C22C 38/00; C23C 2/06; C21D 8/00; C21D 7/06; C21D 6/00; B32B 15/01; C23C 2/34

(52) U.S. Cl. CPC C21D 9/0068; C23C 2/34; B24C 1/10; C22C 38/38; C22C 38/28; C22C 38/06; C22C 38/04; C22C 38/02; C22C 38/002; C23C 2/06; C21D 8/005; C21D 7/06; C21D 6/008; C21D 6/005; C21D 6/002; B32B 15/013; C21D 2211/001

(57) ABSTRACT

Methods of strengthening surface regions of high-strength transformation induced plasticity (TRIP) steel are provided. The method may comprise shot peening at least one region of an exposed surface of a hot-formed press-hardened component comprising a high-strength steel. Prior to shot peening, the component has a microstructure comprising ≧about 5% by volume retained austenite in a matrix of martensite. The shot peening is conducted at a temperature of <about 150° C. and forms at least one hardened surface region comprising ≦about 2% by volume austenite. The TRIP steel may be zinc-coated and having a surface coating comprising zinc and substantially free of liquid metal embrittlement (LME). Zinc-coated hot-formed press-hardened components, including automotive components, formed from such methods are also provided.

### FIELD

The present disclosure relates to a hot-formed press-hardened high-strength steel part with a through-thickness gradient microstructure and methods for making selective surface hardening to form a hot-formed press-hardened high-strength steel part.

### BACKGROUND

This section provides background information related to the present disclosure which is not necessarily prior art.

Press-hardened steel (PHS) is also referred to as “hot-stamped steel” or “boron-steel” (e.g., 22 MnB5 alloy) is one of the strongest steels used for automotive body structural applications, typically having tensile strength properties on the order of about 1,400 megapascals (MPa) or higher. Such a steel alloy has low manganese levels and no aluminum and exhibits desirable properties, including high strength-to-weight ratios. Components formed from PHS have become prevalent in various industries and applications, including general manufacturing, construction equipment, automotive or other transportation industries, home or industrial structures, and the like. PHS components are often used for forming load-bearing components, like structural pillars and door beams, which typically require high strength materials. Thus, the finished state of these steels are designed to have high strength and enough ductility to resist external forces, for example, to resist intrusion of external objects into the passenger compartment without fracturing, so as to provide protection to the occupants.

The PHS steel blank is then austenitized in a furnace. Austenitization is typically conducted in the range of about 880° C. to 950° C. The steel blank may then be hot stamped by being pressed and quenched in dies. In hot stamping of PHS, forming and hardening are combined into a single operation, which may be one of two main types of processes: indirect and direct. Under the direct method, the PHS component is formed and pressed simultaneously between dies, which quenches the steel. The dies may be water-cooled, for example. Under the indirect method, the PHS component is cold formed to an intermediate partial shape before austenitization and the subsequent pressing and quenching steps are then conducted. The quenching of the PHS component hardens the component by transforming the microstructure from austenite to martensite. After the typical indirect or direct PHS processes (after hot forming and quenching), the PHS high-strength steel microstructure is predominantly (e.g., greater than 98%) martensite.

PHS components may require cathodic protection. The PHS component may be coated prior to applicable pre-cold forming (if the indirect process is used) or austenitization. Coating the PHS component provides a protective layer to the underlying steel component. Such coatings typically include an aluminum-silicon alloy and/or zinc. Zinc coatings offer cathodic protection; the coating acts as a sacrificial layer and corrodes instead of the steel component, even where the steel is exposed. However, liquid metal embrittlement (LME) may occur when a metallic system is exposed to a liquid metal, such as zinc, during forming at high temperature, resulting in potential cracking and a reduction of total elongation or diminished ductility of a material. LME may also result in decreased ultimate tensile strength. To avoid LME in conventional PHS processes, numerous additional processing steps are conducted.

Alternative high-strength steel alloy materials to PHS alloy may be used to form press-hardened steel components, such as select high-strength transformation induced plasticity (TRIP) steel like delta-TRIP steel and medium manganese content TRIP steel. However, alternative hot-formed press-hardened structures formed from such select TRIP steels often have microstructures with retained austenite and thus may not have comparable high-strength or hardness levels to comparative PHS structures having fully martensitic microstructures. Further, when such select alternative high-strength TRIP steel alloy materials are galvanized or galvannealed and then press-hardened, they likewise may suffer from LME. Thus, there is an ongoing need for streamlined processes of forming high-strength hot-formed press-hardened steel components having necessary hardness and strength levels, while providing galvanic protection substantially free of LME.

### SUMMARY

This section provides a general summary of the disclosure, and is not a comprehensive disclosure of its full scope or all of its features.

In certain aspects, the present disclosure provides a method of strengthening surface regions of a high-strength steel. The method may comprise shot peening at least one region of an exposed surface of a hot-formed press-hardened component comprising a high-strength transformation induced plasticity (TRIP) steel. The TRIP steel may be selected from the group consisting of:

(i) a Mn-TRIP steel comprising:
manganese (Mn) at greater than or equal to about 4% by weight of the total steel composition, and
carbon (C) at greater than or equal to about 0.1% by weight to less than or equal to about 0.4% by weight, and

(ii) a delta-TRIP steel comprising:
aluminum (Al) at greater than or equal to about 3% by weight to less than or equal to about 6% by weight of the total steel composition;
manganese at greater than or equal to about 0.1% by weight to less than or equal to about 1% by weight of the total steel composition; and
carbon at greater than or equal to about 0.3% by weight to less than or equal to about 0.5% by weight. The hot-formed press-hardened component has a microstructure comprising greater than or equal to about 5% by volume retained austenite in a matrix of martensite. The shot peening is conducted at a temperature of less than or equal to about 150° C. and forms at least one hardened surface region comprising less than or equal to about 1% by volume austenite.

In other aspects, the present disclosure provides a method of strengthening regions of zinc-coated high-strength steel. The method may comprise shot peening at least one region of an exposed surface of a zinc-coated hot-formed press-hardened component comprising a high-strength transformation induced plasticity (TRIP) steel having a surface coating comprising zinc. The TRIP steel may be selected from the group consisting of:

(i) a Mn-TRIP steel comprising:
manganese (Mn) at greater than or equal to about 4% by weight of the total steel composition, and
carbon (C) at greater than or equal to about 0.1% by weight to less than or equal to about 0.4% by weight, and

(ii) a delta-TRIP steel comprising:
aluminum (Al) at greater than or equal to about 3% by weight to less than or equal to about 6% by weight of the total steel composition;
manganese at greater than or equal to about 0.1% by weight to less than or equal to about 1% by weight of the total steel composition; and
carbon at greater than or equal to about 0.3% by weight to less than or equal to about 0.5% by weight. Prior to shot peening, the zinc-coated hot-formed press-hardened component has a microstructure comprising greater than or equal to about 5% by volume retained austenite in a matrix of martensite. The shot peening is conducted at a temperature of less than or equal to about 150° C. and forms at least one hardened surface region comprising less than or equal to about 1% by volume austenite on the component. The component is further substantially free of liquid metal embrittlement (LME).

In yet other aspects, the present disclosure provides a zinc-coated hot-formed press-hardened component. The component comprises at least one hardened surface region comprising less than or equal to about 1% by volume austenite and a center region comprising greater than or equal to about 5% by volume retained austenite in a matrix of martensite. The component comprises a high-strength transformation induced plasticity (TRIP) steel having a surface coating comprising zinc. The TRIP steel may be selected from the group consisting of:

(i) a Mn-TRIP steel comprising:
manganese (Mn) at greater than or equal to about 4% by weight of the total steel composition, and
carbon (C) at greater than or equal to about 0.1% by weight to less than or equal to about 0.4% by weight, and

(ii) a delta-TRIP steel comprising:
aluminum (Al) at greater than or equal to about 3% by weight to less than or equal to about 6% by weight of the total steel composition;
manganese at greater than or equal to about 0.1% by weight to less than or equal to about 1% by weight of the total steel composition; and
carbon at greater than or equal to about 0.3% by weight to less than or equal to about 0.5% by weight. The component is substantially free of liquid metal embrittlement (LME).

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows an exemplary schematic of a high-strength high manganese transformation induced plasticity (TRIP) steel alloy microstructure having a matrix of martensite with a distributed phase of retained austenite after hot forming and press hardening.

FIG. 2 shows a simplified cross-sectional schematic of a zinc-coated sheet blank having a corrosion coating applied to two sides prior to hot forming and press hardening.

FIG. 3 shows an exemplary schematic of a hot-formed press-hardened high-strength high manganese transformation induced plasticity (TRIP) steel alloy microstructure having a matrix of martensite with a distributed phase of retained austenite in a center region and a first surface that is selectively hardened in accordance with certain aspects of the present disclosure.

FIG. 4 shows an exemplary schematic of a hot-formed press-hardened high-strength high manganese transformation induced plasticity (TRIP) steel alloy microstructure having a matrix of martensite with a distributed phase of retained austenite in a center region and two distinct surfaces that are selectively hardened in accordance with yet other aspects of the present disclosure.

FIG. 5 shows an exemplary and simplified cross-sectional view of a shot peening device for shot peening a transformation induced plasticity (TRIP) steel alloy in accordance with other aspects of the present disclosure.

FIG. 6 shows a representative front view of a high-strength structural component in the form of a conventional B-pillar for an automobile.

FIG. 7 shows a detailed side perspective view of a lower portion of a high-strength structural component like that shown in FIG. 6 having two distinct surface hardened regions formed in accordance with certain aspects of the present disclosure.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

As used herein, all amounts are weight % (or mass %), unless otherwise indicated.

In addition, disclosure of ranges includes disclosure of all values and further divided ranges within the entire range, including endpoints and sub-ranges given for the ranges.

As referred to herein, the word “substantially,” when applied to a characteristic of a composition or method of this disclosure, indicates that there may be variation in the characteristic without having a substantial effect on the chemical or physical attributes of the composition or method.

Example embodiments will now be described more fully with reference to the accompanying drawings.

The present disclosure pertains to methods of forming high-strength components from high-strength steel alloys, such as transformation induced plasticity (TRIP) steels. A high-strength steel is one that has an ultimate tensile strength of greater than or equal to about 1,000 megapascals (MPa), for example, greater than or equal to about 1,400 MPa to less than or equal to about 2,200 MPa. In certain aspects, the high-strength TRIP steel alloy comprises manganese at relatively high amounts, for example, at greater than or equal to about 4% by mass or weight of the total the high-strength TRIP steel alloy composition. Such a high-strength TRIP steel alloy having manganese at a nominal amount of above 4% by weight may be considered to be a high-strength high manganese transformation induced plasticity (TRIP) steel alloy microstructure or Mn-TRIP steel. In certain variations, the Mn-TRIP steel alloy may comprise manganese at greater than or equal to about 4% by weight to less than or equal to about 12% by weight of the total composition. The high-strength Mn-TRIP steel alloy may further comprise carbon present at greater than or equal to about 0.1% by weight to less than or equal to about 0.4% by weight.

In certain variations, the high-strength Mn-TRIP steel alloy optionally comprises manganese at greater than or equal to about 4% by weight to less than or equal to about 12% by weight of the total composition; carbon present at greater than or equal to about 0.1% by weight to less than or equal to about 0.4% by weight; one of more of the following alloying ingredients: silicon greater than or equal to about 0.1% by weight to less than or equal to about 0.5% by weight; chromium at less than or equal to about 1% by weight; titanium present at less than or equal to about 0.2% by weight; aluminum present at less than or equal to about 0.1% by weight; phosphorus present less than or equal to about 0.2% by weight; sulfur present less than or equal to about 0.05% by weight; and one or more impurities cumulatively present at less than or equal to about 0.5% by weight, preferably at less than or equal to about 0.1% by weight, and a balance iron.

Suitable variations of a high-strength Mn-TRIP steel alloy may include a 7 Mn-TRIP steel, a 10-Mn-TRIP steel, and the like. 7 Mn-TRIP steel has a nominal manganese content of approximately 7% by weight of the total alloy composition, while 10 Mn-TRIP steel has a nominal manganese content of approximately 10% by weight of the overall alloy composition.

Other high-strength TRIP steel alloys may include delta-TRIP steel (δ-TRIP steel), where the high-strength TRIP steel alloy has a greater concentration of aluminum than silicon. For example, a delta-TRIP steel may have the following composition: aluminum present at greater than or equal to about 3% by weight to less than or equal to about 6% by weight of the total composition; manganese at greater than or equal to about 0.1% by weight to less than or equal to about 1% by weight of the total composition; carbon present at greater than or equal to about 0.3% by weight to less than or equal to about 0.5% by weight; one of more of the following alloying ingredients: silicon greater than or equal to about 0.1% by weight to less than or equal to about 0.5% by weight; chromium at less than or equal to about 1% by weight; titanium present at less than or equal to about 0.2% by weight; phosphorus present less than or equal to about 0.2% by weight; sulfur present less than or equal to about 0.05% by weight; and one or more impurities cumulatively present at less than or equal to about 0.5% by weight, preferably at less than or equal to about 0.1% by weight, and a balance iron.

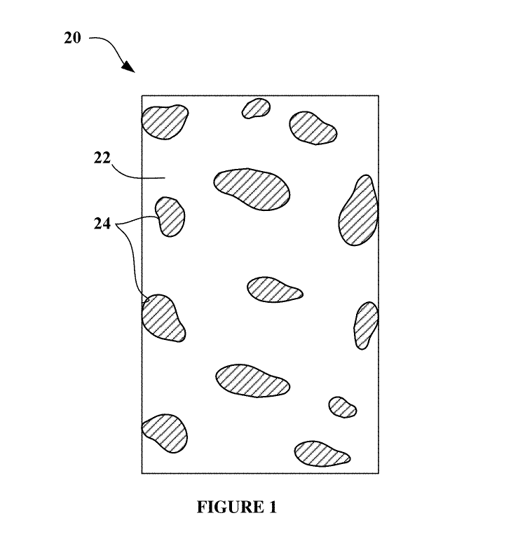

By way of non-limiting example, the methods of the present disclosure pertain to certain high-strength TRIP steels, such as a Mn-TRIP steel, a delta-TRIP steel, and the like. In certain aspects, such select high-strength TRIP steel alloys have a microstructure with a retained austenite embedded in a primary matrix of martensite after a hot stamping and/or press-hardening process. For example, as shown in FIG. 1, a select high-strength Mn-TRIP steel alloy 20 includes a matrix of martensite 22 with a distributed phase of retained austenite 24. The phases as shown in the schematic are merely representative and may have distinct morphology/shapes, sizes, and distributions. Notably, other high-strength alloys, such as press hardened steel (PHS)/boron steels, typically have about 100% martensite after press-hardening and hot stamping. However, the high-strength Mn-TRIP steel alloy 20 has greater than or equal to about 5% by volume to less than or equal to about 30% by volume of retained austenite 24, optionally greater than or equal to about 8% by volume to less than or equal to about 12% by volume, and in certain aspects, about 10% by volume of retained austenite.

By way of background, hot forming of the select high-strength TRIP steels, such as Mn-TRIP steel and delta-TRIP steel may be conducted as follows. A sheet or blank of high-strength TRIP steel alloy may be formed into a three-dimensional component via hot forming. Such a high-strength three-dimensional component may be incorporated into a device, such as a vehicle. While the high-strength structures are particularly suitable for use in components of an automobile or other vehicles (e.g., motorcycles, boats, tractors, buses, motorcycles, mobile homes, campers, and tanks), they may also be used in a variety of other industries and applications, including aerospace components, consumer goods, office equipment and furniture, industrial equipment and machinery, farm equipment, or heavy machinery, by way of non-limiting example. Non-limiting examples of components and vehicles that can be manufactured by the current technology include automobiles, tractors, buses, motorcycles, boats, mobile homes, campers, and tanks. Other exemplary structures that have frames that can be manufactured by the current technology include construction and buildings, such as houses, offices, bridges, sheds, warehouses, and devices. The high-strength structural automotive component may be selected from the group consisting of: rocker rails, structural pillars, A-pillars, B-pillars, C-pillars, D-pillars, bumper, hinge pillars, cross-members, body panels, vehicle doors, roofs, hoods, trunk lids, engine rails, and combinations thereof in certain variations.

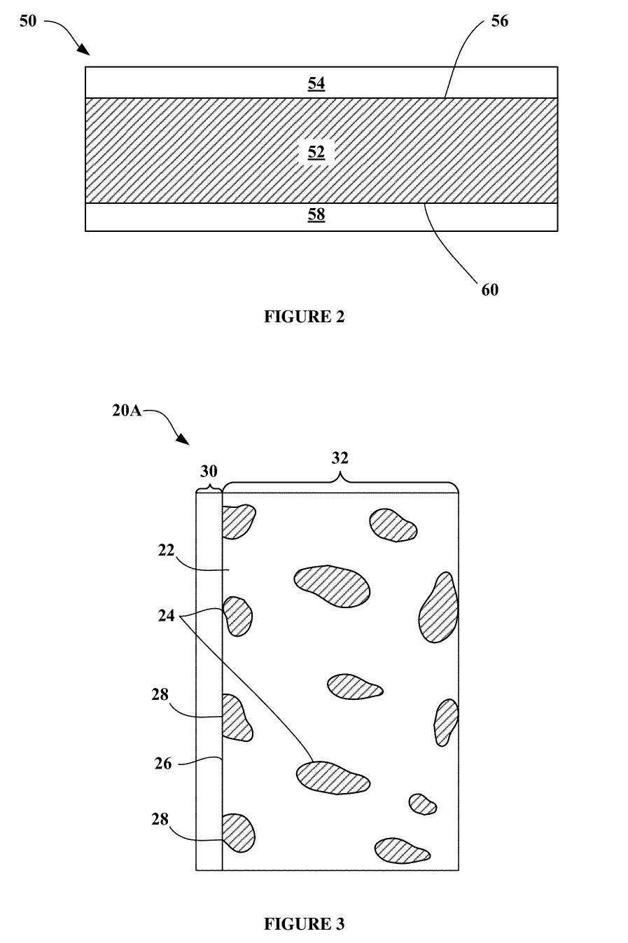

FIG. 2 shows a cross-sectional view of a sheet blank 50 that may be formed from a metal stock or coil in a blanking operation, for example, by cutting. The sheet blank 50 includes a main base layer 52 formed of a high-strength TRIP steel like the compositions previously discussed above. A first coating layer 54 may be formed on a first side 56 of the main base layer 52, while a second coating layer 58 may be formed on a second opposite side 60 of the main base layer 52. While shown on both the first and second sides 56, 60 of the main base layer 52, the first coating layer 54 and the second coating layer 58 may be optionally omitted from either or both sides. In certain aspects, the first coating layer 54 and the second coating layer 58 comprise zinc, for example, such coatings may be zinc or an alloy of zinc and thus predominantly comprise zinc at greater than about 90%. It should be appreciated, however, that the composition of the first coating layer 54 and the second coating layer 58 is not limited to comprising zinc, but may further include additional elements. The sheet blank 50 thus undergoes the hot forming process to provide a three-dimensionally formed component.

During hot forming, the sheet blank may be introduced into a furnace or other heat source. The amount of heat applied to the sheet blank heats and soaks the sheet blank to a temperature of at least the austenitization temperature of the select high-strength TRIP steel. In certain aspects, the high-strength TRIP steel has an austenitization temperature (T₁) of greater than or equal to about 750° C. to less than or equal to about 850° C., optionally less than or equal to about 782° C. in certain variations. Such an austenitization temperature is far below that for typical PHS/boron steels, which are generally at least about 880° C. to 950° C. As will be described further below, in certain aspects, the sheet blank may have a surface layer comprising zinc for corrosion protection. Zinc has a melting temperature of 420° C. and, at 782° C., begins to react with iron via a eutectoid reaction and forms a brittle phase that results in liquid metal embrittlement (LME). Where temperatures are favorable (e.g., above 782° C. in certain high-strength Mn-TRIP steel) and the zinc is a liquid metal, during deformation processes, the zinc can wet freshly exposed grain boundaries (of the phase in the substrate) and cause de-cohesion/separation along the grain boundary. The zinc thus attacks grain boundaries, especially where austenite is present, which can undesirably form cracks associated with LME. The sheet blank is soaked for a period long enough to austenitize the high-strength TRIP steel to a desired level.

After exiting the furnace, the sheet blank can be transferred into a stamping press. The stamping press may include a die having a cooling system or mechanism. For example, the die(s) may have a water-cooling system, which are well known in the art. The die is designed to form a desired final three-dimensional shape of the component from the austenitized sheet blank. The die may include a first forming die and a second forming die that are brought together to form the desired final shape of the three-dimensional component therebetween.

The cooled dies thus may quench the formed sheet blank in a controlled manner across surfaces of the formed component to cause a phase transformation from austenite to martensite. Therefore, the first and second die may cooperate to function as a heat sink to draw heat from, and otherwise quench, the formed component. In certain variations, the high-strength TRIP steel has a critical cooling rate that is the slowest rate of cooling to produce a hardened martensitic condition of greater than about 70 volume % in the component. In one aspect, the critical cooling rate for the high-strength TRIP steel is no greater than about 10 Kelvin/second (K/s). However, it should be appreciated that high-strength TRIP steel may have lower critical cooling rates, such as about 1 K/s. The select high-strength TRIP steels of the present disclosure not only greatly reduce the austenitization temperature, but also significantly shift the ferritic and pearlitic transformation curves of the continuously cooling transformation (CCT) diagram to the right, allowing more time, so the critical cooling rate can be slower. The lower critical cooling rate improves the hardenability of the TRIP steel and makes processing conditions less demanding. For example, the lower critical cooling rate has the following impact on die design: (i) less demand on complex cooling channels, (ii) less sensitivity to die re-tooling, and/or (iii) less demand on uniformity of cooling rate. However, the die may still be cooled as quickly as possible to maintain processing through-put.

As noted above, during the hot forming of the three-dimensional component, the temperature of the sheet blank is desirably kept below about 782° C. to avoid forming a zinc iron (ZnFe) phase/compound, which depletes zinc from the coating layers (the first coating layer 54 and the second coating layer 58 in the sheet blank 50 in FIG. 2). In this manner, LME described above can be significantly reduced or eliminated. As such, an increased zinc concentration on the hot formed component results in improved corrosion protection.

Accordingly, in variations where the starting material has a zinc coating on one or both sides, the press-hardened component is substantially free of liquid metal embrittlement. The zinc coating may be applied by conventional methods, such as hot dip galvanizing. The term “substantially free” as referred to herein means that the LME microstructures and defects are absent to the extent that undesirable physical properties and limitations attendant with their presence are minimized or avoided (e.g., cracking, loss of ductility, and/or loss of strength). In certain embodiments, a PHS component that is “substantially free” of LME defects comprises less than about 5% by weight of the LME species or defects, more preferably less than about 4% by weight, optionally less than about 3% by weight, optionally less than about 2% by weight, optionally less than about 1% by weight, optionally less than about 0.5% and in certain embodiments comprises 0% by weight of the LME species or defects.

A method of press-hardening a high-strength TRIP steel alloy is thus provided that comprises creating a blank having a zinc-coated high-strength TRIP steel alloy. The blank is heated to a temperature of less than or equal to about 782° C. to partially austenitize the zinc-coated steel alloy. The blank is then press hardened and quenched in a die to form a press-hardened component having a multi-phase microstructure, such as the exemplary microstructure 20 formed in FIG. 1. While the retained austenite 26 in the martensite matrix 24 provides greater ductility and/or energy absorption, the retained austenite 26 in the martensite matrix 24 also diminishes hardness as compared with a fully martensitic microstructure. In certain aspects, after hot forming/press hardening, a microstructure is formed that has a retained austenite present at greater than or equal to about 5% to less than or equal to about 30% by volume and a balance of martensite at greater than or equal to about 70% by volume to less than or equal to about 95% by volume. In certain variations, the present disclosure provides methods for selectively increasing a surface hardness of the select high-strength TRIP steel alloys after these hot forming processes.

In certain aspects, the surface hardness is increased via a surface hardening process, such as shot peening. Subjecting one or more surfaces of the hot formed component to shot peening or another surface hardening process serves to transform retained austenite near the surface of the part into martensite. In this manner, a gradient microstructure is formed through a thickness of the part, where the microstructure transitions from a high volume of martensite, for example, 98-100% martensite, into a bulk of the material where the microstructure has less martensite, for example, greater than or equal to about 70% by volume to less than or equal to about 95% by volume with the balance being retained austenite.

As shown in FIG. 3, a hot-formed press-hardened select high-strength Mn-TRIP steel alloy 20A has a microstructure that includes a matrix of martensite 22 with a distributed phase of retained austenite 24. The phases shown in the schematic are merely representative and may have distinct morphology/shapes, sizes, and distributions. However, a first surface 26 of the alloy 20A has been surface hardened by shot peening to form a hardened layer 30 comprising martensite. In certain variations, the martensite in the hardened layer 30 is present at greater than or equal to about 98% by volume, optionally greater than or equal to about 99% by volume, optionally greater than or equal to about 99.5% by volume, optionally greater than or equal to about 99.7% by volume, and in certain variations, optionally greater than or equal to about 99.9% by volume martensite. Stated in another way, the retained austenite in the hardened layer 30 is less than or equal to about 2% by volume, optionally less than or equal to about 1% by volume, optionally less than or equal to about 0.5% by volume, optionally less than or equal to about 0.3% by volume, optionally less than or equal to about 0.1% by volume.

Depending on the nature of the shot peening conducted, a thickness of the hardened layer 30 may have a thickness of greater than 0% of the total thickness of the high-strength Mn-TRIP steel alloy 20A to less than or equal to about 20% of the total thickness of the high-strength Mn-TRIP steel alloy 20A. For example, if a total thickness of the alloy 20A is 2 mm, then the hardened layer 30 may have a thickness ranging from 2% or about 0.04 mm (40 μm) to about 20% or about 0.4 mm (400 μm). While the entire first surface 26 is shown as having a hardened layer 30, the hardened layer 30 may instead be selectively applied to certain regions of the surface, for example, by protecting areas from exposure to the shot during shot peening with a mask/protective barrier or only directing the shot peen towards select regions of the surface.

A central region 32 of the high-strength Mn-TRIP steel alloy 20A remains intact having greater than or equal to about 5% by volume to less than or equal to about 30% by volume of retained austenite 24, optionally greater than or equal to about 8% by volume to less than or equal to about 12% by volume, and in certain aspects, about 10% by volume of retained austenite in the matrix of martensite 22. As can be seen, where retained austenite was present at the first surface of the alloy 20A, it is at least partially transformed into martensite (partially transformed austenite 28 is shown in FIG. 3). A transition region between the hardened layer 30 microstructure and the central region 32 may occur, depending on the nature and extent of the surface hardening process.

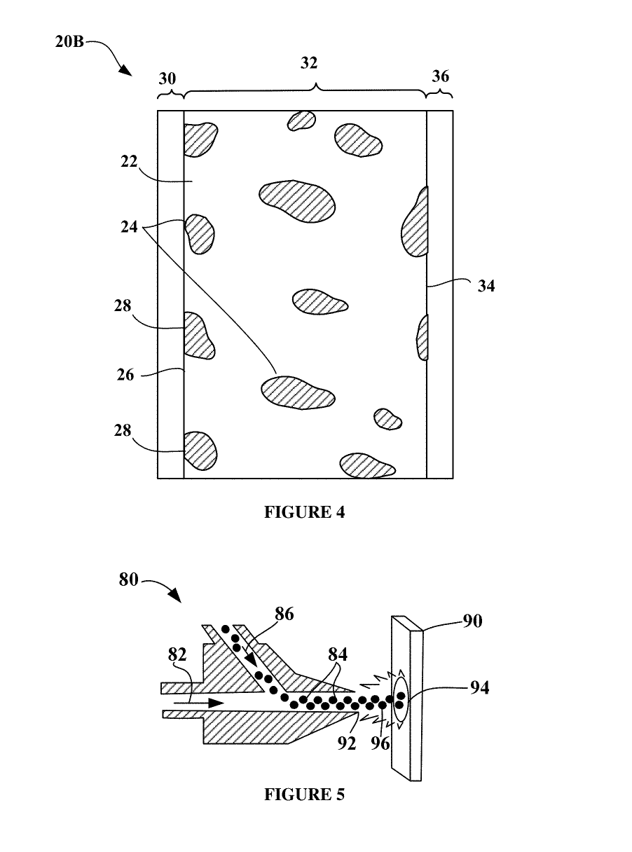

FIG. 4 shows a hot-formed press-hardened select high-strength Mn-TRIP steel alloy 20B that like high-strength Mn-TRIP steel alloy 20A has a first surface 26 that has been surface hardened by shot peening to form a first hardened layer 30 comprising martensite. To the extent that hot-formed press-hardened select high-strength Mn-TRIP steel alloys 20A and 20B in FIGS. 3 and 4 share common features, for brevity, such features will not be discussed again herein unless germane to the new aspects of the hot-formed press-hardened select high-strength Mn-TRIP steel alloy 20B. The high-strength Mn-TRIP steel alloy 20B also has a second surface 34 that has been surface hardened by shot peening to form a second hardened layer 36. Like the microstructure in high-strength Mn-TRIP steel alloy 20A in FIG. 3, the martensite in the first hardened layer 30 or the second hardened layer 36 is present at greater than or equal to about 98% by volume, optionally greater than or equal to about 99% by volume, optionally greater than or equal to about 99.5% by volume, optionally greater than or equal to about 99.7% by volume, and in certain variations, optionally greater than or equal to about 99.9% by volume martensite. Stated in another way, the retained austenite in the first hardened layer 30 or second hardened layer 32 is less than or equal to about 2% by volume, optionally less than or equal to about 1% by volume, optionally less than or equal to about 0.5% by volume, optionally less than or equal to about 0.3% by volume, optionally less than or equal to about 0.1% by volume.

Depending on the nature of the shot peening conducted, a thickness of the first hardened layer 30 may be like previously described above, where a thickness varies from greater than 0% to less than or equal to about 20% of the total thickness of the high-strength Mn-TRIP steel alloy 20B. Likewise, a thickness of the second hardened layer 36 may have a thickness of greater than 0% of the total thickness of the high-strength Mn-TRIP steel alloy 20B to less than or equal to about 20% of the total thickness of the high-strength Mn-TRIP steel alloy 20B. The thicknesses of the first hardened layer 30 and the second hardened layer 36 may be distinct from one another. Furthermore, a total cumulative thickness for all the hardened layers may be a thickness of greater than 0% of the total thickness of the high-strength Mn-TRIP steel alloy 20B to less than or equal to about 40% of the total thickness of the high-strength Mn-TRIP steel alloy 20B. Again, the first hardened layer 30 and the second hardened layer 36 may be selectively applied to certain predetermined regions of either of the first surface 26 or second surface 34 rather than the entire surface. Other surfaces may also be shot peened as needed.

A shot peening process is used on a hot stamped part to transform the surface having retained austenite to martensite and thus forming a hardened surface layer, while the microstructure in the core remains the same. In this manner, the surface can exhibit greater hardness levels, while the core region exhibits greater ductility and/or energy absorption properties due to the presence of higher levels of retained austenite. Thus, a through-thickness gradient microstructure is formed having more martensite on the surface and less martensite in the core. The gradient microstructure can be formed on selected areas of a three-dimensional press-hardened part.

An exemplary and simplified shot peening device 80 is shown in FIG. 5. The shot peening device has a first stream 82 that receives a pressurized gas, such as air. The first stream 82 has a sufficient velocity to entrain a plurality of shot particles 84 and thus may be a jet stream. The pressure, velocity, and volumetric flow rate of the first stream 82 may be adjusted as required to achieve the desired extent of shot peen hardening. A second stream 86 receives the shot peen or shot particles 84. Shot particles 84 for a shot peening process are typically round or oval particles. Exemplary shot particles 84 may have an average particle size diameter of greater than or equal to about 500 μm to less than or equal to about 5000 μm. In certain variations, shot peen media may be selected from the group consisting of: solid carbon dioxide particles (rounded pellets of dry ice), steel shot (steel balls), and combinations thereof. Other suitable ball media for shot peening include those formed from silicon carbide, tungsten carbide, and the like. In certain variations, the shot peen media is cooled to help maintain desirably low temperatures during the shot peening process. The first stream 82 and the second stream 86 may be combined so that the shot particles 84 are entrained in a shot peen stream 96 and carried towards a surface of a substrate 90 to be shot peened. In certain aspects, a range of suitable velocities for the shot peen second stream 96 may be greater than or equal to about 10 m/s to less than or equal to about 500 m/s.

In accordance with certain aspects of the present disclosure, a plurality of shot particles 84 are entrained and shot peened from a nozzle 92 at a selected region 96 of a surface of substrate 90. The shot peening causes transformation of the metastable retained austenite to martensite by applying mechanical energy via cold work and thus facilitating phase transformation and surface hardening. In various aspects of the present disclosure, the surface of the substrate is maintained at a temperature of less than or equal to about 150° C., optionally less than or equal to about 100° C. during the entire shot peening process. An average statistical surface coverage during shot peening may range from greater than or equal to about 200% to less than or equal to about 1,000%.

A microstructure treated in accordance with the methods of the present disclosure can have a hot-formed press-hardened part with improved resistance against bending, by enhancing strength near the surface, with extra martensite generated by shot peening. Further, the shot peening process can mitigate the risks of micro-crack propagation in the zinc-coating in press-hardened component by introducing compressive residual stress at the surface after shot peening. Accordingly, shot peening a press hardened component can improve functional performance of a hot formed steel component (zinc-coated or bare), such as improving fatigue strength and impact under service load (especially bending loads).

In certain aspects, a gradient microstructure through a thickness of a zinc-coated component is obtained by creating a surface layer that is stronger than a core of a made by hot forming process. This can be achieved by a shot peening operation, where shot peen is directed against a surface of a formed part having a microstructure comprising martensite and retained austenite. During shot peening, the retained austenite near the surface transforms to martensite, and hence increasing the strength of the material near the surface. The mechanical performance of the hot stamped component is significantly improved, such as fatigue strength and static/dynamic load bearing capability after the shot peening process.

In certain other aspects, the hot formed components having a zinc coating formed in accordance with the present teachings have improved anti-corrosion performance as compared to conventional aluminum-silicon coated press hardened steel components. As noted above, the austenitization temperature is below the temperature at which undesirable compounds form between zinc and iron, thus helping to minimize LME. After hot forming, the shot peening process further closes micro-cracks in a zinc-coating, thus minimizing or eliminating risk of crack propagation that can cause corrosion. The present technology thus enables zinc-coated press hardened components formed of high-strength TRIP steel having improved corrosion performance formed at a lower cost (compared to conventional aluminum silicon coatings).

The present disclosure thus provides in certain aspects, a zinc-coated hot-formed press-hardened component. The component comprises at least one hardened surface region comprising less than or equal to about 2% by volume austenite, optionally less than or equal to about 1% by volume austenite, and a center region comprising greater than or equal to about 5% by volume retained austenite in a matrix of martensite. The component comprises a high-strength transformation induced plasticity (TRIP) steel having a surface coating comprising zinc. The component is substantially free of liquid metal embrittlement (LME). The TRIP steel may be selected from the group consisting of:

(iii) a Mn-TRIP steel comprising:
manganese (Mn) at greater than or equal to about 4% by weight of the total steel composition, and
carbon (C) at greater than or equal to about 0.1% by weight to less than or equal to about 0.4% by weight, and

(iv) a delta-TRIP steel comprising:
aluminum (Al) at greater than or equal to about 3% by weight to less than or equal to about 6% by weight of the total steel composition;
manganese at greater than or equal to about 0.1% by weight to less than or equal to about 1% by weight of the total steel composition; and carbon at greater than or equal to about 0.3% by weight to less than or equal to about 0.5% by weight. Any of the TRIP steels discussed previously above can form the zinc-coated hot-formed press-hardened component. Likewise, the surface coating comprising zinc may be like those previously described.

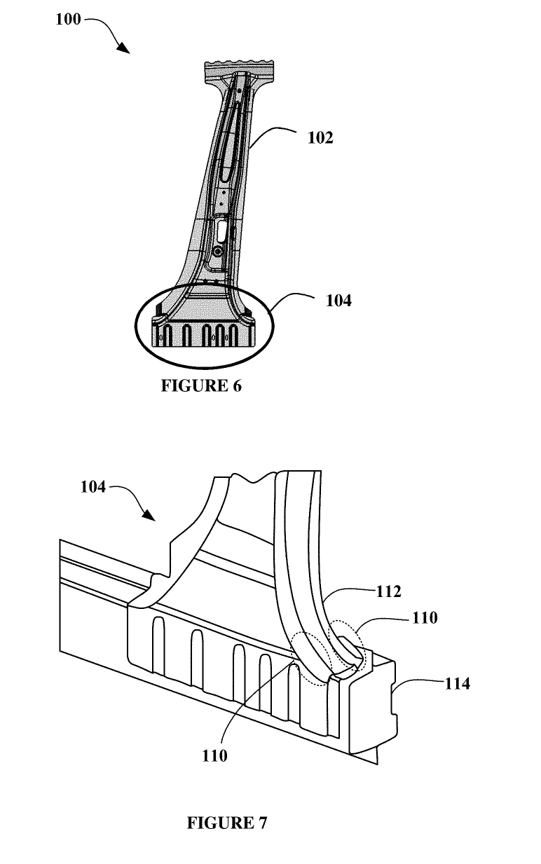

FIG. 6 shows a representative front view of a high-strength structural component in the form of a B-pillar 100 for an automobile. It should be noted that FIGS. 6 and 7 show representative simplified versions of the B-pillar 100 and may have many additional parts joined together to form the B-pillar 100. The B-pillar 100 should have extreme strength in its upper section 102, but a balance of strength and ductility in its lower section 104. The combination of these different properties promotes buckling at a desired location when a force or impact is applied to the B-pillar 100, which may correspond to seat level within the interior of the vehicle to protect the occupant(s) after the force or impact is applied.

FIG. 7 shows a detailed side perspective view of a lower portion 104 of a high-strength structural component B-pillar 100 like that shown in FIG. 6. Two distinct surface hardened regions 110 are formed on a side 112 of the B-pillar 100 near where the B-pillar 100 is attached to a rail 114. The two distinct surface hardened regions 110 increase the surface hardness in these preselected regions and are formed in accordance with the methods of the present disclosure described above. The increased surface hardness in the surface hardened regions 110 increases the strength and hardness at the surface where impact or force may be received; however, the center region of the component still has retained austenite and therefore greater ability to absorb impact energy. In accordance with the present disclosure, high-strength structural automotive components can be made having select surface hardened regions where required. As discussed above, the high-strength structural automotive components may be selected from the group consisting of: rocker rails, structural pillars, A-pillars, B-pillars, C-pillars, D-pillars, bumper, hinge pillars, cross-members, body panels, vehicle doors, roofs, hoods, trunk lids, engine rails, and combinations thereof in certain variations.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of strengthening regions of a high-strength steel, the method comprising:
shot peening at least one region of an exposed surface of a hot-formed press-hardened component comprising a high-strength transformation induced plasticity (TRIP) steel selected from the group consisting of:
a Mn-TRIP steel comprising:
manganese (Mn) at greater than or equal to about 4% by weight of the total steel composition, and
carbon (C) at greater than or equal to about 0.1% by weight to less than or equal to about 0.4% by weight, and
a delta-TRIP steel comprising:
aluminum (Al) at greater than or equal to about 3% by weight to less than or equal to about 6% by weight of the total steel composition;
manganese at greater than or equal to about 0.1% by weight to less than or equal to about 1% by weight of the total steel composition; and
carbon at greater than or equal to about 0.3% by weight to less than or equal to about 0.5% by weight,
wherein the hot-formed press-hardened component has a microstructure comprising greater than or equal to about 5% by volume retained austenite in a matrix of martensite, wherein the shot peening is conducted at a temperature of less than or equal to about 150° C. and forms at least one hardened surface region comprising less than or equal to about 1% by volume austenite.

2. The method of claim 1, wherein the shot peening creates a gradient microstructure from the exposed surface to a center region of the hot-formed press-hardened component.

3. The method of claim 1, wherein the shot peening is conducted at a temperature of less than or equal to about 100° C.

4. The method of claim 1, wherein the shot peening is conducted with shot peen media selected from the group consisting of: solid carbon dioxide particles, steel shot, and combinations thereof.

5. The method of claim 1, wherein the hot-formed press-hardened component has a first thickness and the at least one hardened surface region has a second thickness, wherein the second thickness is greater than 0.1% of the thickness of the first thickness and less than or equal to about 20% of the second thickness.

6. The method of claim 1, wherein the high-strength transformation induced plasticity (TRIP) steel is a Mn-TRIP steel comprising:
manganese (Mn) at greater than or equal to about 4% by weight to less than or equal to about 12% by weight of the total steel composition, and
carbon (C) at greater than or equal to about 0.1% by weight to less than or equal to about 0.4% by weight of the total steel composition;
silicon (Si) at greater than or equal to about 0.1% by weight to less than or equal to about 0.5% by weight of the total steel composition;
chromium (Cr) at less than or equal to about 1% by weight of the total steel composition;
titanium (Ti) at less than or equal to about 0.2% by weight of the total steel composition;
aluminum (Al) at less than or equal to about 0.1% by weight of the total steel composition;
phosphorus (P) at less than or equal to about 0.2% by weight of the total steel composition;
sulfur (S) at less than or equal to about 0.05% by weight of the total steel composition;
one or more impurities cumulatively present at less than or equal to about 0.5% by weight of the total steel composition; and
a balance iron.

7. The method of claim 1, wherein the high-strength transformation induced plasticity (TRIP) steel is a delta-TRIP steel comprising:
aluminum (Al) at greater than or equal to about 3% by weight to less than or equal to about 6% by weight of the total steel composition;
manganese at greater than or equal to about 0.1% by weight to less than or equal to about 1% by weight of the total steel composition;
carbon at greater than or equal to about 0.3% by weight to less than or equal to about 0.5% by weight of the total steel composition;
silicon (Si) at greater than or equal to about 0.1% by weight to less than or equal to about 0.5% by weight of the total steel composition;
chromium (Cr) at less than or equal to about 1% by weight of the total steel composition;
titanium (Ti) at less than or equal to about 0.2% by weight of the total steel composition;
phosphorus (P) at less than or equal to about 0.2% by weight of the total steel composition;
sulfur (S) at less than or equal to about 0.05% by weight of the total steel composition;
one or more impurities cumulatively present at less than or equal to about 0.5% by weight of the total steel composition; and
a balance iron.

8. The method of claim 1, prior to the shot peening further comprising:
heating a blank comprising a high-strength TRIP steel to a temperature of less than or equal to about 782° C. to austenitize the high-strength TRIP steel; and press hardening the blank in at least one die to press and quench the blank to form the hot-formed press-hardened component.

9. The method of claim 1, wherein the at least one hardened surface region comprises less than 0.5% by volume austenite.

10. The method of claim 1, wherein the exposed surface includes a first surface and a second opposite surface of the hot-formed press-hardened component, wherein the at least one hardened surface region cover the first surface and the second surface.

11. A method of strengthening regions of a zinc-coated high-strength steel, the method comprising:
shot peening at least one region of an exposed surface of a zinc-coated hot-formed press-hardened component comprising a high-strength transformation induced plasticity (TRIP) steel having a surface coating comprising zinc, the steel selected from the group consisting of:
a Mn-TRIP steel comprising:
manganese (Mn) at greater than or equal to about 4% by weight of the total steel composition, and
carbon (C) at greater than or equal to about 0.1% by weight to less than or equal to about 0.4% by weight, and
a delta-TRIP steel comprising:
aluminum (Al) at greater than or equal to about 3% by weight to less than or equal to about 6% by weight of the total steel composition;
manganese at greater than or equal to about 0.1% by weight to less than or equal to about 1% by weight of the total steel composition; and
carbon at greater than or equal to about 0.3% by weight to less than or equal to about 0.5% by weight,
wherein the zinc-coated hot-formed press-hardened component has a microstructure comprising greater than or equal to about 5% by volume retained austenite in a matrix of martensite, wherein the shot peening is conducted at a temperature of less than or equal to about 150° C. and forms at least one hardened surface region comprising less than or equal to about 1% by volume austenite and the component is substantially free of liquid metal embrittlement (LME).

12. The method of claim 11, wherein the shot peening seals microcracks in the surface coating of the exposed surface of the zinc-coated hot-formed press-hardened component.

13. The method of claim 11, wherein the shot peening creates a gradient microstructure from the exposed surface to a center region of the zinc-coated hot-formed press-hardened component.

14. The method of claim 11, wherein the shot peening is conducted with shot peen media selected from the group consisting of: solid carbon dioxide particles, steel shot, and combinations thereof.

15. The method of claim 11, wherein the zinc-coated hot-formed press-hardened component has a first thickness and the at least one hardened surface region has a second thickness, wherein the second thickness is greater than 0.1% of the thickness of the first thickness and less than or equal to about 20% of the second thickness.

16. The method of claim 11, wherein the high-strength transformation induced plasticity (TRIP) steel is:
(i) a Mn-TRIP steel comprising:
manganese (Mn) at greater than or equal to about 4% by weight to less than or equal to about 12% by weight of the total steel composition, and
carbon (C) at greater than or equal to about 0.1% by weight to less than or equal to about 0.4% by weight of the total steel composition;
silicon (Si) at greater than or equal to about 0.1% by weight to less than or equal to about 0.5% by weight of the total steel composition;
chromium (Cr) at less than or equal to about 1% by weight of the total steel composition;
titanium (Ti) at less than or equal to about 0.2% by weight of the total steel composition;
aluminum (Al) at less than or equal to about 0.1% by weight of the total steel composition;
phosphorus (P) at less than or equal to about 0.2% by weight of the total steel composition;
sulfur (S) at less than or equal to about 0.05% by weight of the total steel composition;
one or more impurities cumulatively present at less than or equal to about 0.5% by weight of the total steel composition; and
a balance iron; or
(ii) a delta-TRIP steel comprising:
aluminum (Al) at greater than or equal to about 3% by weight to less than or equal to about 6% by weight of the total steel composition;
manganese at greater than or equal to about 0.1% by weight to less than or equal to about 1% by weight of the total steel composition;
carbon at greater than or equal to about 0.3% by weight to less than or equal to about 0.5% by weight of the total steel composition;
silicon (Si) at greater than or equal to about 0.1% by weight to less than or equal to about 0.5% by weight of the total steel composition;
chromium (Cr) at less than or equal to about 1% by weight of the total steel composition;
titanium (Ti) at less than or equal to about 0.2% by weight of the total steel composition;
phosphorus (P) at less than or equal to about 0.2% by weight of the total steel composition;
sulfur (S) at less than or equal to about 0.05% by weight of the total steel composition;
one or more impurities cumulatively present at less than or equal to about 0.5% by weight of the total steel composition; and
a balance iron.

17. The method of claim 11, wherein the at least one hardened surface region comprises less than 0.5% by volume austenite.

18. A zinc-coated hot-formed press-hardened component comprising:
at least one hardened surface region comprising less than or equal to about 1% by volume austenite and a center region comprising greater than or equal to about 5% by volume retained austenite in a matrix of martensite, wherein the component comprises a high-strength transformation induced plasticity (TRIP) steel having a surface coating comprising zinc, wherein the steel is selected from the group consisting of:
a Mn-TRIP steel comprising:
manganese (Mn) at greater than or equal to about 4% by weight of the total steel composition, and
carbon (C) at greater than or equal to about 0.1% by weight to less than or equal to about 0.4% by weight, and
a delta-TRIP steel comprising:
aluminum (Al) at greater than or equal to about 3% by weight to less than or equal to about 6% by weight of the total steel composition;
manganese at greater than or equal to about 0.1% by weight to less than or equal to about 1% by weight of the total steel composition; and
carbon at greater than or equal to about 0.3% by weight to less than or equal to about 0.5% by weight, wherein the component is substantially free of liquid metal embrittlement (LME).

19. The zinc-coated hot-formed press-hardened component of claim 18, wherein the high-strength transformation induced plasticity (TRIP) steel is:
(i) a Mn-TRIP steel comprising:
manganese (Mn) at greater than or equal to about 4% by weight to less than or equal to about 12% by weight of the total steel composition, and
carbon (C) at greater than or equal to about 0.1% by weight to less than or equal to about 0.4% by weight of the total steel composition;
silicon (Si) at greater than or equal to about 0.1% by weight to less than or equal to about 0.5% by weight of the total steel composition;
chromium (Cr) at less than or equal to about 1% by weight of the total steel composition;
titanium (Ti) at less than or equal to about 0.2% by weight of the total steel composition;
aluminum (Al) at less than or equal to about 0.1% by weight of the total steel composition;
phosphorus (P) at less than or equal to about 0.2% by weight of the total steel composition;
sulfur (S) at less than or equal to about 0.05% by weight of the total steel composition;
one or more impurities cumulatively present at less than or equal to about 0.5% by weight of the total steel composition; and
a balance iron; or
(ii) a delta-TRIP steel comprising:
aluminum (Al) at greater than or equal to about 3% by weight to less than or equal to about 6% by weight of the total steel composition;
manganese at greater than or equal to about 0.1% by weight to less than or equal to about 1% by weight of the total steel composition;
carbon at greater than or equal to about 0.3% by weight to less than or equal to about 0.5% by weight of the total steel composition;
silicon (Si) at greater than or equal to about 0.1% by weight to less than or equal to about 0.5% by weight of the total steel composition;
chromium (Cr) at less than or equal to about 1% by weight of the total steel composition;
titanium (Ti) at less than or equal to about 0.2% by weight of the total steel composition;
phosphorus (P) at less than or equal to about 0.2% by weight of the total steel composition;
sulfur (S) at less than or equal to about 0.05% by weight of the total steel composition;
one or more impurities cumulatively present at less than or equal to about 0.5% by weight of the total steel composition; and
a balance iron.

20. The zinc-coated hot-formed press-hardened component of claim 18, wherein a gradient microstructure is created from the at least one hardened surface region and the center region.
